(19) United States
(12) Patent Application Publication
(10) Pub. No.: US 2013/0017372 A1
(43) Pub. Date: Jan. 17, 2013

(54) FLEXIBLE MAT WITH MULTIPLE FOAM LAYERS

(71) Applicants: Chris Mechling, San Diego, CA (US); Nick Mechling, San Diego, CA (US)

(72) Inventors: Chris Mechling, San Diego, CA (US); Nick Mechling, San Diego, CA (US)

(21) Appl. No.: 13/353,005

(22) Filed: Jan. 18, 2012

Related U.S. Application Data
(60) Provisional application No. 61/433,841, filed on Jan. 18, 2011.
(60) Provisional application No. 61/473,378, filed on Apr. 8, 2011.
(60) Provisional application No. 61/487,758, filed on May 19, 2011.

(51) Int. Cl. B32B 3/06; B32B 3/26; B32B 38/04

(52) U.S. Cl. 428/192; 156/268

(57) ABSTRACT

A flexible, foam-based mat comprising: a bottom layer of foam comprising four lateral edges, wherein a first smooth lateral edge is opposing a second smooth lateral edge, and a third lateral edge comprising a plurality of protrusions opposes a fourth lateral edge comprising a plurality of intrusions, further wherein the plurality of protrusions have complementary dimensions with the plurality of intrusions; a top layer of foam comprising four lateral edges; and a surface layer that covers the top layer of foam, further wherein the bottom layer and top layer are segmented with horizontal scoring extending across the width of the mat from the first smooth lateral edge to the second smooth lateral edge.

### CROSS REFERENCES

This application claims priority from U.S. Provisional Application No. 61/433,841 filed Jan. 18, 2011, U.S. Provisional Application No. 61/473,378 filed Apr. 8, 2011 and U.S. Provisional Application No. 61/487,758 filed May 19, 2011, the contents of which are all incorporated by reference herein.

### FIELD OF THE INVENTION

This invention relates generally to the field of athletic floor mats. Specifically, the present invention relates to mats comprised of layers of foam with the capability of interlocking multiple mats together in a unified fashion.

### BACKGROUND OF THE INVENTION

Over the years, there have been many examples of exercise mats for use in gymnastics, martial arts, wrestling (and similar activities) that have attempted to provide a cushioned support for high degrees of force applied on the top surface of the mat. For example, many of the activities occurring on the top surface of the mat involve individuals being thrown onto the top surface of the mat, replete with all of the inherent forces that come with such activities. Accordingly, these mats have been designed to not only withstand high degrees of downward forces applied to the top surface of the mats, but many mats have been designed to provide a cushioned support to protect the individuals.

U.S. Pat. No. 3,319,273 to Solin was an early example of a type of gymnasium mat built to provide some layer of support for high-impact activities occurring on the top surface of the mat. This mat allowed for a resilient, shock-absorbing floor wherein the mats could be linked up in a contiguous fashion. However, the mats required a fastener strip consisting of zippers which attached individual mats together. Additionally, there existed only one layer of material, which consisted of likely cotton, wool or some like material.

U.S. Pat. No. 3,526,911 to Meyer et al. was a gradual evolution of the then-existing art in the field of exercise mats. This mat provided for a better means of attaching mats by providing strips of material that sandwiched the fastener element between mats. Additionally, the filler material within the mats consisted of foam plastic or foam rubber, which was a slight improvement over the prior mats. However, these mats could only be folded on top of each segment, resulting in a bulky mass usually requiring multiple individuals to carry each set of mats. Furthermore, these mats still consisted of only one later of support, with the material inside of each mat being only slightly more cushioned than earlier generations of mats.

U.S. Pat. No. 5,212,842 to Glydon discloses an interlockable foam pad capable of forming larger structures for use as child's exercise/play mat. Each mat is comprised of three layers of foam and the mats were connected to each other by male/female sections used to create a singular mat structure or three dimensional structures (ie. cubes). The foam used in these mats consisted of very low density polyethylene, such as cross-linked, closed-cell polyethylene foam, with the thickness of this core foam layer being substantially greater than the thickness of the top and bottom layers. While suitable for children, these mats would be unsuitable for high-impact exercises (ie. martial arts) by adults, wherein the downward forces applied to the top surface of the mat would be too great given the densities associated with very low density polyethylene. Further, the interlocking features that enabled the mats to connect to one another leaves exposed seams at the top surface, which would be a great disadvantage to adult users engaging in high-impact activities in light of the sheer forces involved, in additional to the risk of injury with the exposed seams at the surface.

U.S. Design Pat. No. D545,934 to Hardy et al. disclosed an ornamental design for a martial arts training mat for use as a teaching mat. However, this mat consisted of only one, thin layer of material and was meant primarily as a teaching tool for a student to maintain their body in specific positions with respect to the martial arts being practiced. This mat would be incapable of providing any cushioned support for high-impact uses. Further, the mat was designed as a large circle with no possibility of interlocking easily with any other mat.

International Application No. PCT/US02/39078 filed by Heartsfield discloses a method for manufacturing a mat capable of providing cushioned support having a seamless top surface. The mat further provides for a segmented aspect on the underneath surface of the mat, allowing the mat to roll up in a compact fashion. However, this method of manufacturing only provides for a mat consisting of a single layer of polyethylene foam. While this may enable a more compact way of storing the mat, it greatly increases the risk of injury if high-impact exercises are performed on the top surface of the mat. More importantly, this mat may not be interlocked or combined easily with other mats, as there is no ability to zip, connect or attach in any way another mat having similar dimensions.

U.S. Patent Publication No. 2011/0003110 filed by Heartsfield exemplifies yet another embodiment within this field. In this case, there is disclosed a mat connecting system, enabling a covert way to connect various mats without exposing the connection means at the surface. This may better protect users, though it is unlikely that such a connecting means can withstand high-impact usage at the surface. Additionally, this art is limiting in that it may only be folded into bulky components, without the ability to roll into compact forms. Most importantly, the polyethylene foam material used is not consistent with allowing the dispersion of high energy forces often found in specific uses (ie. martial arts). Thus, there still exists a need to solve the deficiencies observed in the art for having a flexible, highly supportive, energy dispersing foam material with a stable, interlocking component system for high-impact usages.

### SUMMARY OF THE INVENTION

The present invention provides for a flexible, foam-based mat comprising: a bottom layer of foam comprising four lateral edges, wherein a first smooth lateral edge is opposing a second smooth lateral edge, and a third lateral edge comprising a plurality of protrusions opposes a fourth lateral edge comprising a plurality of intrusions, further wherein the plurality of protrusions have complementary dimensions with the plurality of intrusions; a top layer of foam comprising four lateral edges; and a surface layer that covers the top layer of foam, further wherein the bottom layer and top layer are segmented with horizontal scoring extending across the width of the mat from the first smooth lateral edge to the second smooth lateral edge.

One object of the present invention provides for the top layer and the bottom layer of the mat comprising foam of equal densities. Optionally, the top layer and the bottom layer of the mat may comprise foam of different densities.

A further embodiment of the present invention provides for the top layer and the bottom layer of the mat being bonded to each other. Additionally, the surface layer of the mat is bonded to the top layer by the same process as that which bonds the top layer and the bottom layer. Optionally, the surface layer is bonded to the top layer by a different process as that which bonds the top layer and the bottom layer. Additionally, all layers may be pre-treated with antibacterial, antifungal, antimicrobial or germicidal compositions.

In another embodiment, the horizontal scoring does not extend vertically through the top layer. Optionally, the horizontal scoring extends vertically through the top layer and stops before reaching the surface layer.

In yet another embodiment, a middle layer is present between the top layer and bottom layer of the mat, providing for additional cushioned support. In a preferred embodiment, the middle layer is less dense than the top layer and the bottom layer. Additionally, the horizontal scoring extends vertically through the middle layer.

In a further embodiment, the present invention provides for a flexible, foam-based mat comprising: a bottom layer of foam comprising four lateral edges, wherein the four lateral edges contain a plurality of protrusions and intrusions, further wherein the plurality of protrusions have complementary dimensions with the plurality of intrusions; a middle layer of foam comprising four lateral edges; a top layer of foam comprising four lateral edges; and a surface layer that covers the top layer of foam, further wherein the bottom layer, the middle layer and top layer are segmented with horizontal scoring extending across the width of the mat from a first lateral edge to a second lateral edge.

Another object of the present invention provides for a method of manufacturing a flexible, foam-based mat comprising: providing a bottom layer of foam comprising four lateral edges, wherein a first smooth lateral edge is opposing a second smooth lateral edge, and a third lateral edge comprising a plurality of protrusions opposes a fourth lateral edge comprising a plurality of intrusions, further wherein the plurality of protrusions have complementary dimensions with the plurality of intrusions; providing a top layer of foam comprising four lateral edges; providing a surface layer that covers the top layer of foam; bonding the bottom layer of foam to the top layer of foam; bonding the surface layer to the top layer of foam; and scoring the bottom layer through the top layer in a horizontal fashion in segments, wherein the segments are spaced apart by a width from about 2 inches to about 6 inches and extending across the width of the mat from the first smooth lateral edge to the second smooth lateral edge. Preferably, the segments are spaced apart by a distance of about 4 inches.

In a preferred embodiment, the method provides for a surface layer bonded to the top layer by the same process as that which bonds the top layer and the bottom layer. Optionally, the method provides for a surface layer is bonded to the top layer by a different process as that which bonds the top layer and the bottom layer. Additionally, all layers may be pre-treated with antibacterial, antifungal, antimicrobial or germicidal compositions.

In yet another embodiment, the method of the present invention further include providing a middle layer between the top layer and bottom layer. Preferably, the middle layer is less dense than the top layer and the bottom layer. Additionally, the horizontal scoring extends vertically through the middle layer.

Another object of the present invention provides for a method of manufacturing a flexible, foam-based mat comprising: providing a bottom layer of foam comprising four lateral edges, wherein the four lateral edges contain a plurality of protrusions and intrusions, further wherein the plurality of protrusions have complementary dimensions with the plurality of intrusions; providing a middle layer of foam comprising four lateral edges; providing a top layer of foam comprising four lateral edges; providing a surface layer that covers the top layer of foam; bonding the bottom layer of foam to the middle layer of foam; bonding the middle layer of foam to the top layer of foam; bonding the surface layer to the top layer of foam; and scoring the bottom layer through the top layer in a horizontal fashion in segments, wherein the segments are spaced apart by a width from about 2 inches to about 6 inches and extending across the width of the mat from the first smooth lateral edge to the second smooth lateral edge. Preferably, the segments are spaced apart by a distance of about 4 inches.

Further objects and advantages of the present invention will be apparent from the following description of the preferred embodiments when considered in conjunction with the accompanying drawings.

### BRIEF DESCRIPTION OF THE DRAWINGS

FIG. 1 is a perspective view of one embodiment of the present invention showing the interlocking of panel embodiments of the present invention;

FIG. 2A is a perspective view of one embodiment of the present invention showing one panel with multiple layers;

FIG. 2B is an exploded perspective view showing the layers of one embodiment of the present invention.

FIG. 3 is a top view of the bottom layer of another embodiment of the present invention;

FIG. 4 is an angled view of the rolling feature of one embodiment of the present invention;

FIG. 5 is a top view of the bottom layer of one embodiment of the present invention depicting bow the panels interlock in relationship with each other.

Similar reference characters denote corresponding features consistently throughout the attached drawings.

### DETAILED DESCRIPTION OF THE INVENTION

Compositions according to the present invention comprise a flexible, foam-based mat capable of folding into a compact form due to the construction and materials used. For example, the type of foam used is preferably ethylene vinyl acetate, or EVA. This is a substantial improvement over the mats described in the prior art, as most mats in the prior art are composed of polyethylene.

EVA is distinct from polyethylene material in many ways, both in terms of structure and function. Below are the chemical structures of EVA and polyethylene:

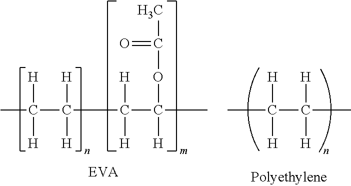

EVA foam has been used extensively across a variety of industries, from sporting goods to photovoltaic cell construction. As foam, it is known for its shock-absorbing qualities. A preferred object of the present invention is to provide an EVA-based mat which will provide an improvement over the prior art in terms of shock-absorbing features and durability.

In an additional aspect of the present invention, the EVA-based mat will provide a means of spreading out the force of the high-impact, high-force activities conducted on the mat surface by varying the densities among the layers of EVA foam. In one embodiment, the mat will be comprised of a top layer of EVA foam and a bottom layer of EVA foam. Each layer of EVA foam may be of different or equal densities. In a preferred embodiment, the mat will be comprised of a top layer of EVA foam and a bottom layer of EVA foam, each layer being of greater density than a middle layer of EVA foam. This will provide stability and support at the top and bottom layers, while the lighter density of the EVA foam within the middle layer will enable the energy from the high-impact activities at the top surface to be spread out across the mat and through the three layers of EVA foam with varying densities. The result will be a softer mat, which is a tremendous benefit for activities within the martial arts, including judo, karate, jiu-jitsu, mixed martial arts, wrestling or grappling.

Compositions according to the present invention further include interlocking features enabling mats to be linked to each other in a contiguous fashion. The interlocking ability is attributed to the location of the interlocking features. Within the bottom layer of a single mat, there are four lateral edges: a first lateral edge is completely smooth and is opposite a second lateral edge, which is also completely smooth. A third lateral edge comprises at least one protrusion and is of complementary dimensions to a fourth lateral edge comprising at least one intrusion. Preferably, the number of protrusions along the third lateral edge equals the number of intrusions along the fourth lateral edge. The protrusions on one mat will have complementary dimensions with the intrusions available on another mat in order to form the interlocking bridging of contiguous mats. The protrusions may take any angled or circular shape, so long as there are complementary dimensions available for the intrusions.

The present invention comprises several embodiments, namely those mats which are comprised of panels made up of substantially square dimensions. Another embodiment of the present invention is mats comprised of rolls made up of substantially rectangular dimensions. Both embodiments are described herein and are often used interchangeably. The preferred ranges of dimensions for the panels are between 1 to 3 inches in thickness, between 10 and 40 inches wide and between 10 and 40 inches in length. The preferred ranges of dimensions for the rolls are between 1 to 3 inches in thickness, between 4 to 7 feet wide and between 25 to 50 feet long.

Compositions according to the present invention further include a pre-treatment of any or all layers with antibacterial, antifungal, antimicrobial or germicidal compositions. Such compositions may be applied at any time during the manufacturing process (or post-manufacturing). The application of these various compositions will provide an improved hygiene element to the mat and, coupled with the absence of stitching or seams on the surface layer, will be safer and greatly reduce the potential for infections common in the mats of the prior art.

Compositions according to the present invention further include an EVA-based foam mat having a sliced or scoring feature comprising horizontal cuts starting in the bottom layer and proceeding vertically through the top layer. In the three layer (bottom, middle, top) embodiment, the sliced or scoring feature extends vertically through all three layers. Optionally, the sliced or scoring feature will extend entirely through the top layer but stopping before the surface layer. Alternatively, the sliced or scoring feature will extend through most of the top layer but not entirely through the top layer. The horizontal scoring extends across the width of the mat in the bottom layer from the first smooth lateral edge to the second smooth lateral edge. The sliced or scoring feature results in the formation of segments of the mat, allowing the mat to roll into a compact shape for storing and transport. The segments are spaced apart at a distance from about 2 inches to about 6 inches. Preferably, the segments are spaced apart at a distance of about 4 inches.

Methods according to the present invention include manufacturing a flexible, foam-based mat comprising providing a bottom layer and a top layer of foam, as detailed above. The bottom layer may be bonded to the top layer. In an alternative embodiment, the bottom layer is bonded to a middle layer and the middle layer is bonded to the top layer. Chemical, thermal or mechanical methods may be used to bond the layers together. Preferably, the layers are chemically bonded together using glue and a heat source. The surface layer may be bonded to the top layer by the same bonding process used to bond the other layers. Alternatively, the surface layer may be bonded to the top layer by a different bonding process as that which was used to bond the other layers. Additionally, all layers may be pre-treated with antibacterial, antifungal, antimicrobial or germicidal compositions at any time during or after the manufacturing process.

Methods according to the present invention further include a slicing or scoring step in the manufacturing process comprising horizontal cuts starting in the bottom layer and proceeding vertically through the top layer. In the three layer (bottom, middle, top) embodiment, the sliced or scoring feature extends vertically through all three layers. Optionally, the sliced or scoring feature will extend entirely through the top layer but stopping before the surface layer. Alternatively, the sliced or scoring feature will extend through most of the top layer but not entirely through the top layer. The horizontal scoring extends across the width of the mat in the bottom layer from the first smooth lateral edge to the second smooth lateral edge. The sliced or scoring feature results in the formation of segments of the mat, allowing the mat to roll into a compact shape for storing and transport. The segments are spaced apart at a distance from about 2 inches to about 6 inches. Preferably, the segments are spaced apart at a distance of about 4 inches.

As detailed in FIG. 1, the flexible, foam-based mat 10 is comprised, in one embodiment, of a plurality of panels 60 have a bottom layer 30 which interlocks with other panels 60 at the bottom layer 30 of each panel using a series of protrusions 32 and intrusions 33 having complementary dimensions to afford a stable fit. There is a top layer 45 and, optionally, a middle layer 40, wherein the bottom layer is bonded 47 to the middle layer 40 which is bonded 47 to the top layer 45. A surface layer 50 is bonded (not shown) to the top layer 45, with a seam 51 running in parallel fashion to other seams along the surface layer 50. Optionally, smooth lateral edges 34 of the panels 60 may be used as an end border. Alternatively, all lateral edges of the panels 60 have a plurality of protrusions or intrusions (not shown). The bottom layer 30, the middle layer 40 and the top layer 45 are segmented with horizontal scoring 31 which extends across the width of the mat from a first smooth lateral edge 34 to a second smooth lateral edge 34.

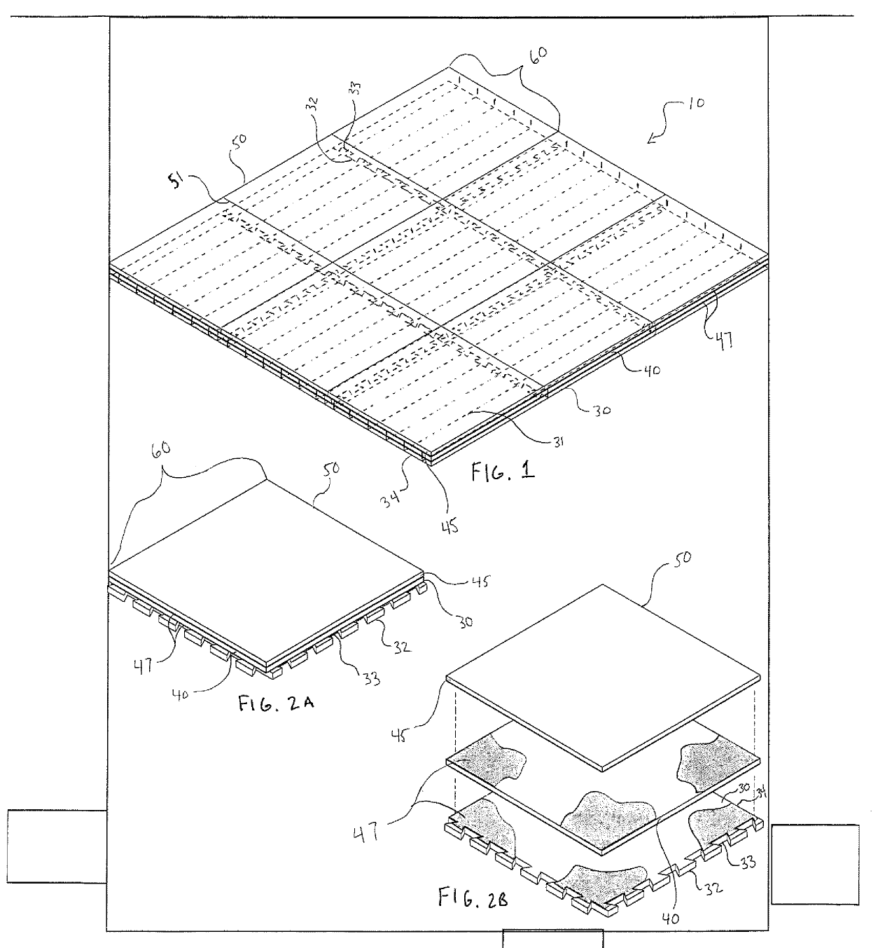

With regard to FIG. 2A, one panel 60 is observed having three layers. The bottom layer 30 is depicted with protrusions 32 and intrusions 33, being bonded 47 to the middle layer 40, which is bonded 47 to the top layer 45. The surface layer 50 is bonded to the top later 45.

With regard to FIG. 2B, the layers is shown during the bonding process. Preferably, the layers are bonded 47 by a chemical process.

As detailed in FIG. 3, a closer view of how the protrusions 32 interlock with the intrusions 33 on the bottom layer 30 on two mats is shown. In this roll-up mat embodiment, there is a substantially rectangular dimension to each mat, wherein the smooth lateral edges 34 are on the short arms of the rectangular mats, while the protrusions 32 and intrusions 33 are along the long arms of the rectangular mats, along the mats to intersect at each of the long arms of each mat.

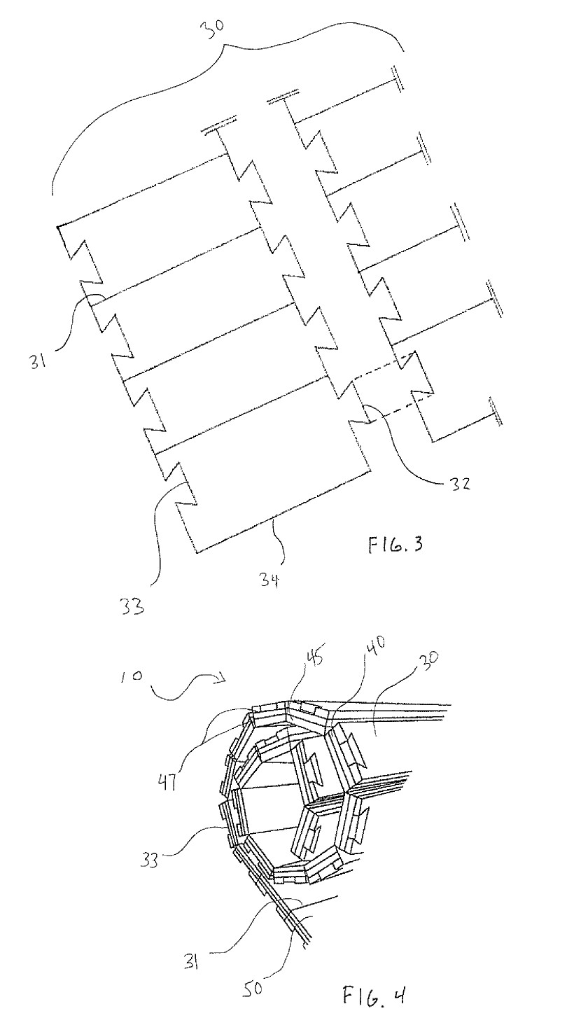

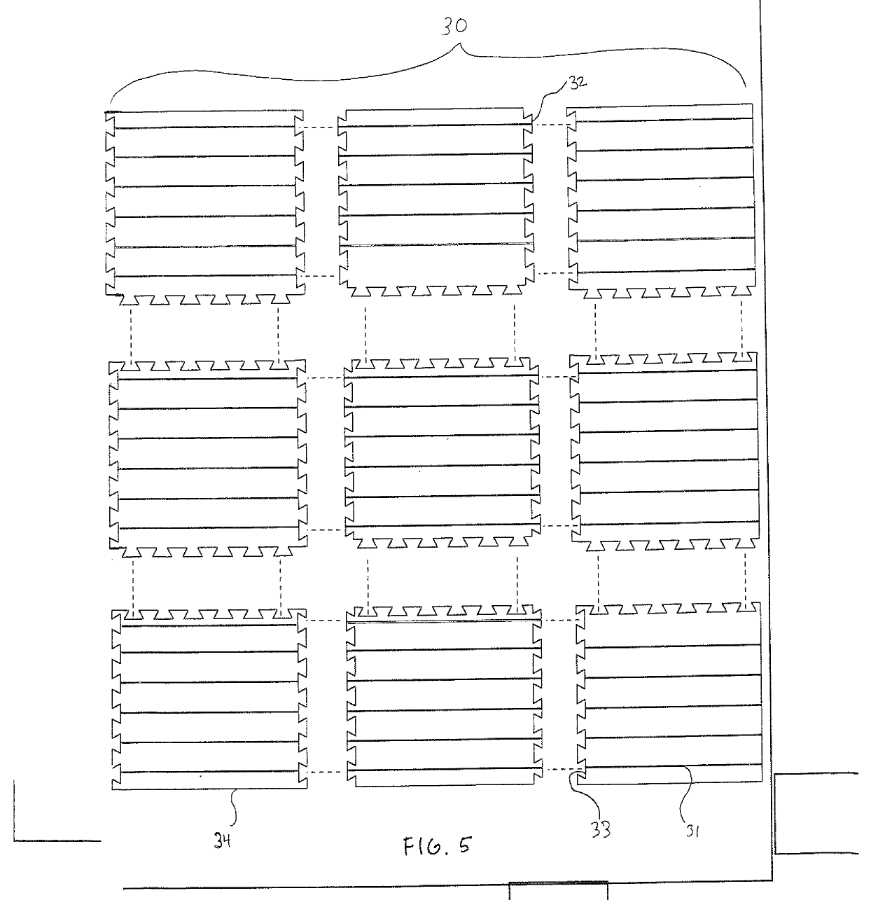

As further detailed in FIG. 4, the roll-up embodiment rectangular mat is depicted, wherein the mat 10 is able to be rolled into a compact shape, with a high degree of bending being accomplished due to the horizontal scoring 31 at regular intervals through the layers (30, 40 and 45) of the mat 10.

As further described in FIG. 5, the bottom layer 30 is shown interlocking in one embodiment of the present invention. In this embodiment, there are a plurality of smooth lateral edges 34, resulting in an enlarged mat having four sides, wherein three of the sides are made up of borders having smooth lateral edges 34, while the remaining side has the plurality of protrusions 32 and intrusions 33. This allows the mat to be extended laterally, while maintaining the upper and lower borders of the mat as smooth lateral edges 34 within the bottom layer 30.

As used in this specification and in the appended claims, the singular forms include the plural forms. For example the terms “a,” “an,” and “the” include plural references unless the content clearly dictates otherwise. Additionally, the term “at least” preceding a series of elements is to be understood as referring to every element in the series. The inventions illustratively described herein can suitably be practiced in the absence of any element or elements, limitation or limitations, not specifically disclosed herein. Thus, for example, the terms “comprising,” “including,” “containing,” etc. shall be read expansively and without limitation. Additionally, the terms and expressions employed herein have been used as terms of description and not of limitation, and there is no intention in the use of such terms and expressions of excluding any equivalents of the future shown and described or any portion thereof, and it is recognized that various modifications are possible within the scope of the invention claimed. Thus, it should be understood that although the present invention has been specifically disclosed by preferred embodiments and optional features, modification and variation of the inventions herein disclosed can be resorted by those skilled in the art, and that such modifications and variations are considered to be within the scope of the inventions disclosed herein. The inventions have been described broadly and generically herein. Each of the narrower species and subgeneric groupings falling within the scope of the generic disclosure also form part of these inventions. This includes the generic description of each invention with a proviso or negative limitation removing any subject matter from the genus, regardless of whether or not the excised materials specifically resided therein. In addition, where features or aspects of an invention are described in terms of the Markush group, those schooled in the art will recognize that the invention is also thereby described in terms of any individual member or subgroup of members of the Markush group. It is also to be understood that the above description is intended to be illustrative and not restrictive. Many embodiments will be apparent to those in the art upon reviewing the above description. The scope of the invention should therefore be determined not with reference to the above description, but should instead be determined with reference to the appended claims, along with the full scope of equivalents to which such claims are entitled. Those skilled in the art will recognize, or will be able to ascertain using no more than routine experimentation, many equivalents to the specific embodiments of the invention described. Such equivalents are intended to be encompassed by the following claims.

What is claimed is:

1. A flexible, foam-based mat comprising:
(a) a bottom layer of foam comprising four lateral edges, wherein a first smooth lateral edge is opposing a second smooth lateral edge, and a third lateral edge comprising a plurality of protrusions opposes a fourth lateral edge comprising a plurality of intrusions, further wherein the plurality of protrusions have complementary dimensions with the plurality of intrusions;
(b) a top layer of foam comprising four lateral edges; and
(c) a surface layer that covers the top layer of foam,
further wherein the bottom layer and top layer are segmented with horizontal scoring extending across the width of the mat from the first smooth lateral edge to the second smooth lateral edge.

2. The mat according to claim 1, wherein the top layer and the bottom layer comprise foam of equal densities.

3. The mat according to claim 1, wherein the top layer and the bottom layer comprise foam of different densities.

4. The mat according to claim 1, wherein the top layer and the bottom layer are chemically bonded to each other.

5. The mat according to claim 1, wherein the surface layer is bonded to the top layer by the same process as that which bonds the top layer and the bottom layer.

6. The mat according to claim 1, wherein the surface layer is bonded to the top layer by a different process as that which bonds the top layer and the bottom layer.

7. The mat according to claim 1, wherein the horizontal scoring does not extend vertically through the top layer.

8. The mat according to claim 1, wherein the horizontal scoring extends vertically through the top layer and stops before reaching the surface layer.

9. The mat according to claim 1, wherein a middle layer is present between the top layer and bottom layer.

10. The mat according to claim 9, further wherein the middle layer is less dense than the top layer and the bottom layer.

11. The mat according to claim 9, further wherein the horizontal scoring extends vertically through the middle layer.

12. A method of manufacturing a flexible, foam-based mat comprising:
(a) providing a bottom layer of foam comprising four lateral edges, wherein a first smooth lateral edge is opposing a second smooth lateral edge, and a third lateral edge comprising a plurality of protrusions opposes a fourth lateral edge comprising a plurality of intrusions, further wherein the plurality of protrusions have complementary dimensions with the plurality of intrusions;
(b) providing a top layer of foam comprising four lateral edges;
(c) providing a surface layer that covers the top layer of foam;
(d) bonding the bottom layer of foam to the top layer of foam;
(e) bonding the surface layer to the top layer of foam; and
(e) scoring the bottom layer through the top layer in a horizontal fashion in segments, wherein the segments are spaced apart by a width from about 2 inches to about 6 inches and extending across the width of the mat from one smooth lateral edge to the second smooth lateral edge.

13. The method according to claim 12, wherein the segments are spaced apart by a distance of about 4 inches.

14. The method according to claim 12, wherein the surface layer is bonded to the top layer by the same process as that which bonds the top layer and the bottom layer.

15. The method according to claim 12, wherein the surface layer is bonded to the top layer by a different process as that which bonds the top layer and the bottom layer.

16. The method according to claim 12, wherein a middle layer is provided between the top layer and bottom layer.

17. The method according to claim 16, further wherein the middle layer is less dense than the top layer and the bottom layer.

18. The method according to claim 16, further wherein the horizontal scoring extends vertically through the middle layer.

19. The mat according to claim 9, wherein all layers of foam are composed of ethylene vinyl acetate or EVA.

20. The method according to claim 16, where all layers of foam are composed of ethylene vinyl acetate or EVA.

21. A flexible, foam-based mat comprising:
(a) a bottom layer of foam comprising four lateral edges, wherein the four lateral edges contain a plurality of protrusions and intrusions, further wherein the plurality of protrusions have complementary dimensions with the plurality of intrusions;
(b) a middle layer of foam comprising four lateral edges;
(b) a top layer of foam comprising four lateral edges; and
(c) a surface layer that covers the top layer of foam,
further wherein the bottom layer, the middle layer and top layer are segmented with horizontal scoring extending across the width of the mat from a first lateral edge to a second lateral edge, wherein the horizontal scoring is perpendicular to the first lateral edge and the second lateral edge.
